(19) United States
(12) Patent Application Publication
(10) Pub. No.: US 2025/0294009 A1
(43) Pub. Date: Sep. 18, 2025

(54) SYSTEMS AND METHODS FOR MANAGEMENT OF NETWORK PROTOCOLS WHILE SUPPORTING MULTI-TENANCY

(71) Applicant: Hedgehog Sonic Foundation, Seattle, WA (US)

(72) Inventors: Amit G. LIMAYE, FREMONT, CA (US); Sergei LUKIANOV, SAN JOSE, CA (US)

(21) Appl. No.: 19/083,301

(22) Filed: Mar. 18, 2025

Related U.S. Application Data
(60) Provisional application No. 63/566,849, filed on Mar. 18, 2024.

(51) Int. Cl. H04L 61/5014; H04L 12/46; H04L 45/64

(52) U.S. Cl. CPC H04L 61/5014; H04L 12/4641; H04L 45/64

(57) ABSTRACT

A multi-tenant system includes a DHCP relay agent and a DHCP server. The DHCP relay agent obtains a first broadcasted DHCP message from a first host within a first Virtual Local Area Network (VLAN); determines first tenant attribute information of the first host; augments the first broadcasted DHCP message with the determined first tenant attribute information and transmits a unicast augmented first DHCP message to the DHCP server. The DHCP relay agent obtains a second broadcasted DHCP message from a second host within a second VLAN, determines second tenant attribute information of the second host, augments the second broadcasted DHCP message with the determined second tenant attribute information, and transmits a unicast augmented second DHCP message to the DHCP server. The DHCP server identifies a first tenant associated with the first host, a second tenant associated with the second host, assigns IP addresses to the first and second tenants.

### CROSS-REFERENCE TO RELATED APPLICATION

This application claims benefit of U.S. Provisional Application No. 63/566,849, filed Mar. 18, 2024, which is hereby incorporated by reference in its entirety.

### TECHNICAL FIELD

This disclosure pertains to management of network protocols such as dynamic host configuration protocol (DHCP) while supporting a multi-tenant network.

### BACKGROUND

Multi-tenant support in a network is fundamental for modern data centers. One aspect of multi-tenant support includes isolation among different tenants at different infrastructure layers including the network. Another aspect of multi-tenant support is handling potentially overlapping network addresses such as internet protocol (IP) addresses, which may occur when different tenants request an overlapping or same IP address space. Current approaches that attempt to support multi-tenancy in a network have shortcomings. Therefore, a solution to manage network protocols such as DHCP to better support multi-tenancy is needed.

### SUMMARY

A claimed solution rooted in computer technology overcomes problems specifically arising in the realm of computer technology. Embodiments of the present invention implement a dynamic host configuration protocol (DHCP) server system within a multi-tenant system. Although the foregoing refers to DHCP for the sake of illustration, the solution is not to be construed as being limited to DHCP, but rather, may be implemented in conjunction with other network protocols.

The DHCP server system overcomes existing shortcomings in computer networking, particularly in network configuration. One shortcoming is that current DHCP systems are unaware of multi-tenancy within the network. At least some of the hosts within the network may belong to multiple tenants. Each tenant may include a shared group of users (e.g., one or more computing devices) which share access to a particular partition within a network. In one embodiment, a tenant may, within a particular partition, utilize resources including processors, memory, virtual systems, services, application programs, load balancers, firewalls, and/or the like. At least some of the different tenants may request overlapping internet protocol (IP) address subspaces. As a result, current DHCP systems may be unable to support multi-tenancy, in particular, for allocation and assigning of IP addresses and provisioning of tenant configuration parameters. This shortcoming severely limits current computer networks.

The DHCP server system is configured to perform network functionalities for hosts, at least some of which may belong to different tenants. The network functionalities include implementing management policies for IP addresses, such as allocating and assigning IP addresses to hosts, maintaining a mapping between the assigned IP addresses and the tenants, and provisioning host tenant configuration parameters specific to the tenants. The DHCP server system performs these network functionalities without having to deploy a separate server for each different tenant. The DHCP server thereby supports multi-tenancy, maintaining secure communications among tenants, while conserving computing resources which would otherwise be consumed by deploying separate servers or server instances for each tenant.

In some embodiments, the DHCP server system includes a DHCP server and a DHCP relay agent. Upon obtaining a DHCP message from a host, the DHCP relay agent augments the DHCP message and transmits the augmented DHCP message to the DHCP server, so that the DHCP server becomes aware of an identity of a particular tenant associated with the host. In some embodiments, the DHCP relay agent augments the message with tenant attribute information which may include a unique combination of a Virtual Local Area Network (VLAN) identifier and a Virtual Routing and Forwarding (VRF) identifier for the host. The VLAN identifier may refer to a particular VLAN assigned to the tenant associated with the host. The VRF identifier may refer to a particular VRF assigned to the tenant associated with the host.

In some embodiments, the DHCP relay agent augments a particular field of the DHCP message such as a tenant attribute field of the DHCP message. Upon augmenting the DHCP message, the DHCP relay agent forwards the augmented DHCP message to the DHCP server. If the DHCP message were not augmented, the tenant attribute information would not be transmitted to the DHCP server. Therefore, the augmenting of the DHCP message by the DHCP relay agent permits the DHCP server to support multi-tenancy.

The DHCP server may, from the tenant attribute information within the augmented DHCP message, identify a tenant based on the network topology information. The DHCP server may also store, or otherwise access, tenant IP address information which includes IP address allocation information mapped to each tenant. The IP address allocation information may include permitted IP address subranges assigned to each tenant and tenant configuration parameters to be provisioned to each tenant.

By identifying a tenant associated with the host that transmitted the DHCP message, the DHCP server system assigns IP addresses and provisions tenant configuration parameters specific to the tenant. The DHCP server system thus greatly streamlines computing operations within a network by responding to multiple tenants within a same network without consuming additional computing resources. Otherwise, if multiple tenants were forced to exist on different networks, consumption of computing resources would be greatly increased as a result of deployment of computing resources within different networks. Because the number of tenants may be on a scale of thousands of tenants or more, forcing multiple tenants to exist on different networks would be infeasible.

An additional computing benefit resulting from augmenting the DHCP message may be an increased layer of network security. At a first layer, the DHCP relay agent may, upon detecting a non-conforming message, refrain from forwarding that message to the DHCP server or refrain from augmenting that message. In some embodiments, non-conforming messages may include corrupted, suspicious, or malicious messages. In some embodiments, non-conforming messages may fail to conform to certain formats, fail to include certain fields, or have information within the fields deemed to be non-conforming. At a second layer, the DHCP server may authenticate DHCP messages based on presence of tenant attribute information within the DHCP messages. If a DHCP message were to lack the tenant attribute information, the DHCP server may flag that DHCP message as non-conforming, and may drop the message or implement other security measures.

In some embodiments, a multi-tenant Dynamic Host Configuration Protocol (DHCP) server system comprises a DHCP relay agent and a DHCP server, the DHCP server system comprising one or more hardware processors memory storing computer instructions, the computer instructions when executed by the one or more hardware processors configured to perform operations. The operations include, in a first process: obtaining, by the DHCP relay agent, a first broadcasted DHCP message from a first host within a first Virtual Local Area Network (VLAN); determining, by the DHCP relay agent, first tenant attribute information of the first host based on switch configuration information; augmenting, by the DHCP relay agent, the first broadcasted DHCP message with the determined first tenant attribute information; converting, by the DHCP relay agent, the first broadcasted DHCP message to a unicast form; and transmitting, by the DHCP relay agent, the unicast augmented first DHCP message to the DHCP server. The operations further include, in a second process: obtaining, by the DHCP relay agent, a second broadcasted DHCP message from a second host within a second VLAN; determining, by the DHCP relay agent, second tenant attribute information of the second host based on switch configuration information; augmenting, by the DHCP relay agent, the second broadcasted DHCP message with the determined second tenant attribute information; converting, by the DHCP relay agent, the second broadcasted DHCP message to a unicast form; and transmitting, by the DHCP relay agent, the unicast augmented second DHCP message to the DHCP server. The operations include, in a third process: identifying, based on the unicast augmented first DHCP message, by the DHCP server, a first tenant associated with the first host; identifying, based on the unicast augmented second DHCP message, by the DHCP server, a second tenant associated with the second host; assigning, by the DHCP server, a first Internet Protocol (IP) address to the first host from a first allocated subspace of IP addresses for the first tenant and a second IP address to the second host from a second allocated subspace of IP addresses for the second tenant; and provisioning first tenant configuration parameters for the first host and second tenant configuration parameters for the second host.

In some embodiments, the first process and the second process may constitute preprocessing steps which not only reduce computing resources consumed by the DHCP server but also enable the DHCP server to support multi-tenancy. This constitutes an improvement in computing technology because it avoids the DHCP server from being overburdened, which would increase possibility of overheating or other malfunctioning. At the same time, this obviates the need to deploy multiple DHCP servers. In some embodiments, the first process and the second process, and the third process, may be performed continuously without interruption. That is, while the DHCP server is performing the third process for the first host and the second host, the DHCP relay agent may be performing the first and second processes for other hosts such as a third host and a fourth host. This creates a continuous streamlined workflow of processes performed by the DHCP server and the DHCP relay agent.

In some embodiments, the switch configuration information may be associated with the first VLAN and the second VLAN. In some embodiments, the switch configuration information may correspond to a switch on which the DHCP relay agent resides, is programmed within, or is embedded. In some embodiments, the DHCP server system includes the switch. In some embodiments, the switch configuration information may include a subset of network topology information stored at the DHCP server, in particular, the subset relating to ports that are on the switch while excluding other ports not on the switch but residing on other switches.

In some embodiments, the first allocated subspace and the second allocated subspace are at least partially overlapping.

In some embodiments, the first tenant attribute information comprises a first VLAN identifier and a first Virtual Routing and Forwarding (VRF) identifier which identifies a first routing instance for the first broadcasted DHCP message, and the second tenant attribute information comprises a second VLAN identifier and a second VRF identifier which identifies a second routing instance for the second broadcasted DHCP message.

In some embodiments, the switch configuration information comprises a first mapping between the first tenant attribute information and first host connection information, and a second mapping between the second tenant attribute information and second host connection information.

In some embodiments, the determining, by the DHCP relay agent, first tenant attribute information of the first host comprises: determining the first host connection information based on the first VLAN identifier; and deriving the first VRF identifier based on the first host connection information and the switch configuration information. In some embodiments, the determining, by the DHCP relay agent, second tenant attribute information of the second host comprises: determining the second host connection information based on the second VLAN identifier; and deriving the second VRF identifier based on the second host connection information and the switch configuration information.

In some embodiments, the DHCP relay agent is implemented on a switch, the first host connection information defines a first connection of the first host to a first port on the switch and the second host connection information defines a second connection of the second host to a second port on the switch.

In some embodiments, the first DHCP message comprises a first DHCP discover message; and assigning, by the DHCP server, a first IP address to the first host comprises: transmitting, to the DHCP relay agent, a first DHCP offer message in unicast form that includes the assigned first IP address; converting, by the DHCP relay agent, the first DHCP offer message into a broadcast first DHCP offer message; and transmitting, to the first host, by the DHCP relay agent, the broadcast first DHCP offer message.

In some embodiments, the assigning, by the DHCP server, a first IP address to the first host comprises: obtaining, by the DHCP relay agent, a first broadcasted DHCP request message from the first host within the first VLAN in broadcast form; determining, by the DHCP relay agent, the first tenant attribute information of the first host based on the switch configuration information; augmenting, by the DHCP relay agent, the first broadcasted DHCP request message with the determined first tenant attribute information; converting, by the DHCP relay agent, the first broadcasted DHCP request message to a unicast form; and transmitting, by the DHCP relay agent, the unicast augmented first DHCP request message to the DHCP server.

In some embodiments, the computer instructions when executed by the one or more hardware processors are further configured to perform: detecting, by the DHCP server, a third DHCP message devoid of tenant attribute information; flagging, by the DHCP server, the third DHCP message as nonconforming; and dropping, by the DHCP server, the third DHCP message.

In some embodiments, augmenting, by the DHCP relay agent, the first broadcasted DHCP message comprises adding the first tenant attribute information to a tenant attribute field within a header of the DHCP message.

In some embodiments, provisioning may encompass setting additional IP-related parameters or otherwise managing assigned IP addresses for different tenants.

In some embodiments, a method implemented by a multi-tenant Dynamic Host Configuration Protocol (DHCP) server system comprising a DHCP relay agent and a DHCP server performs operations as described above.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1A is a block diagram of a network system that includes a dynamic host configuration protocol (DHCP) server system that supports multi-tenancy, in accordance with some embodiments of the present invention.

FIG. 1B is a block diagram illustrating further details of the network system illustrated in FIG. 1A, in accordance with some embodiments of the present invention.

FIG. 2A is a block diagram illustrating details of a DHCP relay agent within the DHCP server system, in accordance with some embodiments of the present invention.

FIG. 2B is a diagram illustrating details of a DHCP message transmitted by a host, in accordance with some embodiments of the present invention.

FIG. 3 is a diagram illustrating details of operations performed by the DHCP relay agent, in accordance with some embodiments of the present invention.

FIG. 4 is a diagram illustrating details of an augmented DHCP message following augmenting by the DHCP relay agent, in accordance with some embodiments of the present invention.

FIG. 5 is a block diagram illustrating details of a DHCP server within the DHCP server system, in accordance with some embodiments of the present invention.

FIG. 6 is a block diagram illustrating details of a DHCP database within the DHCP server system, in accordance with some embodiments of the present invention.

FIG. 7 is a flowchart of a method of assigning internet protocol (IP) addresses and provisioning host tenant configuration parameters while supporting multi-tenancy, in accordance with some embodiments of the present invention.

FIG. 8 is a block diagram illustrating details of a computing system.

### DETAILED DESCRIPTION

A claimed solution rooted in computer technology overcomes problems specifically arising in the realm of computer technology. Embodiments of the present invention implement a dynamic host configuration protocol (DHCP) server system within a multi-tenant system. Although the foregoing refers to DHCP for the sake of illustration, the solution is not to be construed as being limited to DHCP, but rather may be implemented in conjunction with other network protocols.

The DHCP server system overcomes existing shortcomings in computer networking, particularly in network configuration. One shortcoming is that current DHCP systems are unaware of multi-tenancy within the network. At least some of the hosts within the network may belong to multiple tenants. Each tenant may include a shared group of users (e.g., one or more computing devices) which share access to a particular partition within a network. In one embodiment, a tenant may, within a particular partition, utilize resources including processors, memory, virtual systems, services, application programs, load balancers, firewalls, and/or the like. At least some of the different tenants may request overlapping internet protocol (IP) address subspaces. As a result, current DHCP systems may be unable to support multi-tenancy, in particular, for allocation and assigning of IP addresses and provisioning of tenant configuration parameters. This shortcoming severely limits current computer networks.

The DHCP server system is configured to perform network functionalities for hosts, at least some of which may belong to different tenants. The network functionalities include allocating and assigning IP addresses to hosts, maintaining a mapping between the assigned IP addresses and the tenants, and provisioning host tenant configuration parameters specific to the tenants. The DHCP server system performs these network functionalities without having to deploy a separate server for each different tenant. The DHCP server thereby supports multi-tenancy, maintaining secure communications among tenants, while conserving computing resources which would otherwise be consumed by deploying separate servers or server instances for each tenant.

In some embodiments, the DHCP server system includes a DHCP server and a DHCP relay agent. Upon obtaining a DHCP message from a host, the DHCP relay agent augments the DHCP message and transmits the augmented DHCP message to the DHCP server, so that the DHCP server becomes aware of an identity of a particular tenant associated with the host. In some embodiments, the DHCP relay agent augments the message with tenant attribute information which may include a unique combination of a Virtual Local Area Network (VLAN) identifier and a Virtual Routing and Forwarding (VRF) identifier for the host. The VLAN identifier may refer to a particular VLAN assigned to the tenant associated with the host. The VRF identifier may refer to a particular VRF assigned to the tenant associated with the host.

In some embodiments, the DHCP relay agent augments a particular field of the DHCP message such as a tenant attribute field of the DHCP message. Upon augmenting the DHCP message, the DHCP relay agent forwards the augmented DHCP message to the DHCP server. If the DHCP message were not augmented, the tenant attribute information would not be transmitted to the DHCP server. Therefore, the augmenting of the DHCP message by the DHCP relay agent permits the DHCP server to support multi-tenancy.

The DHCP server may, from the tenant attribute information within the augmented DHCP message, identify a tenant based on the network topology information. The DHCP server may also store, or otherwise access, tenant IP address information which includes IP address allocation information mapped to each tenant. The IP address allocation information may include permitted IP address subranges assigned to each tenant and tenant configuration parameters to be provisioned to each tenant.

By identifying a tenant associated with the host that transmitted the DHCP message, the DHCP server system assigns IP addresses and provisions tenant configuration parameters specific to the tenant. The DHCP server system thus greatly streamlines computing operations within a network by responding to multiple tenants within a same network without consuming additional computing resources. Otherwise, if multiple tenants were forced to exist on different networks, consumption of computing resources would be greatly increased as a result of deployment of computing resources within different networks. Because the number of tenants may be on a scale of thousands of tenants or more, forcing multiple tenants to exist on different networks would be infeasible.

An additional computing benefit resulting from augmenting the DHCP message may be an increased layer of network security. At a first layer, the DHCP relay agent may, upon detecting a non-conforming message, refrain from forwarding that message to the DHCP server or refrain from augmenting that message. In some embodiments, non-conforming messages may include corrupted, suspicious, or malicious messages. In some embodiments, non-conforming messages may fail to conform to certain formats, fail to include certain fields, or have information within the fields deemed to be non-conforming. At a second layer, the DHCP server may authenticate DHCP messages based on presence of tenant attribute information within the DHCP messages. If a DHCP message were to lack the tenant attribute information, the DHCP server may flag that DHCP message as non-conforming, and may drop the message or implement other security measures.

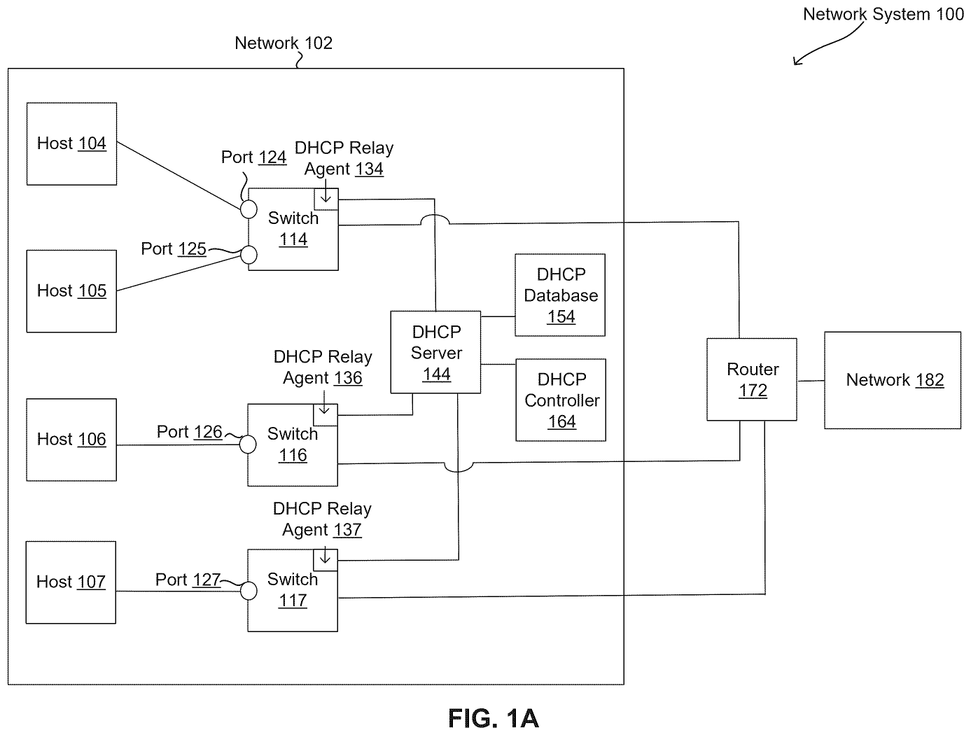

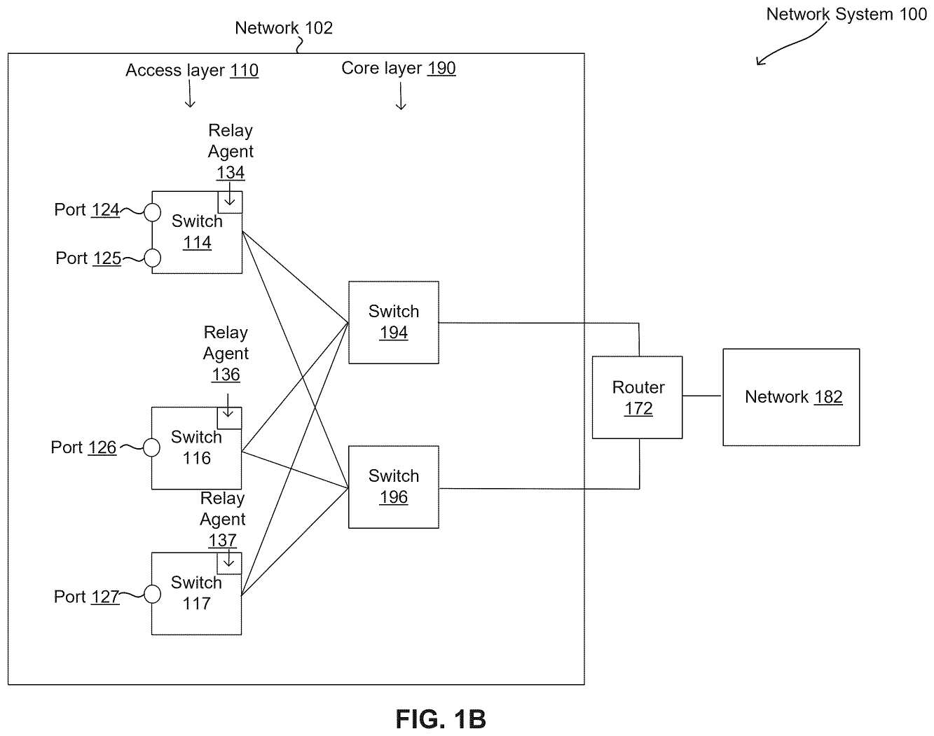

FIG. 1A is a block diagram of a network system 100 that includes a DHCP server system that supports multi-tenancy, in accordance with some embodiments of the present invention. The teachings of FIG. 1 may be implemented in conjunction with any of the embodiments herein. In FIG. 1A, the network system 100 may include a network 102, a network 182, and a router 172 that transmits packets between the networks 102 and 182. In some embodiments, the networks 102 and 182 may include any type of network such as a local area network (LAN), a Wireless Local Area Network (WLAN), or a Wide Area Network (WAN). In some embodiments, the networks 102 and 182 may include the Internet, and may be public or private. Although the embodiments describe herein IP-based networks, the networks 102 and 182 are not to be construed as being limited to IP-based networks. In some embodiments, the networks 102 and 182 may implement a non-IP based network. In some embodiments, the router 172 may transmit messages over different sets of routes using network layer, or layer 3 (L3) communications, according to the Open Systems Interconnection (OSI) model. In some embodiments, the DHCP server system may include the DHCP server 144, and any or all of the DHCP database 154, the DHCP controller 164, the DHCP relay agent 134, the DHCP relay agent 136, and the DHCP relay agent 137.

Within the network 102, each of hosts 104, 105, 106, and 107 may connect to a specific port on a switch to connect to the network 102. Although only four hosts 104, 105, 106, and 107 are shown in FIG. 1A, the network 102 may have any number of hosts, and likely has thousands of hosts or more. The hosts 104, 105, 106, 107 may include client devices or computing devices, and one or more of the hosts may belong to different tenants. In some embodiments, the hosts 104, 105, 106, 107 may include physical or virtual devices. For example, any of the hosts 104, 105, 106, 107 may include virtualized containers or server processes. Here, for illustration, it is assumed that each of the hosts 104, 105, 106, and 107 belongs to a different tenant. In one embodiment, a tenant includes a service entity such as AT&T, Netflix, Verizon, and/or the like. A tenant may provide a subset of resources (e.g., products or services) of a larger entity. For example, AT&T internet products may be a particular tenant, and AT&T security products may be another tenant.

Each client device may include a desktop, laptop, notebook, tablet, personal digital assistant, smart phone, or other consumer electronic device incorporating one or more computer components. Each client device may include a client system, which may include hardware, software, or firmware for communicating with the network 102 or other networks (e.g., the network 182) or accessing any resources within the network 102 or the network 182. Examples of the client systems may include web browsers, client engines, drivers, user interface components, proprietary interfaces, and/or the like.

Each of switches 114, 116, and 117 may include multiple ports. For illustrative purposes, the switch 114 has ports 124 and 125 (along with other ports), the switch 116 has a port 126 (along with other ports), and the switch 117 has a port 127 (along with other ports). The host 104 is connected to the port 124. The host 105 is connected to the port 125. The host 106 is connected to the port 126. The host 107 is connected to the port 127. The specific arrangement of the switches, ports, and hosts shown in FIG. 1A is merely exemplary, and not to be construed as limiting. Each of the switches 114, 116, and 117 may be connected, directly or indirectly, with the router 172. As will be illustrated in more detail in FIG. 1B, the network 102 may contain multiple layers of switches. If the network contains a second layer of switches on top of the switches 114, 116, and 117, then the switches 114, 116, and 117 may be indirectly connected to the router 172.

The switches 114, 116, and 117 may be Layer 3 switches, and be instantiated with Virtual Routing and Forwarding (VRF) to establish separate routing instances for different hosts that belong to different tenants. In some embodiments, within each VRF instance, one or more Virtual Local Area Networks (VLANs) may constitute separate broadcast domains that further partition the hosts. In some embodiments, having nested VLANs within each VRF instance provides efficient separate of message traffic based on both Layer 2 (VLAN) and Layer 3 (VRF). In some embodiments, more than one port may be assigned to a same VRF and each port may be assigned to only a single VLAN. A VLAN may identify traffic on a particular port. In some embodiments, a VLAN interface may route traffic within a corresponding VLAN based on routing protocols. A VLAN interface may be a virtual interface, and may have an IP address.

A DHCP server 144 may include hardware, software or firmware configured to initialize a new host that attempts to join the network 102 by assigning tenant attributes for the new host. The tenant attributes may include a VLAN identifier and a VRF identifier for the new host. The tenant attributes may be stored as part of network topology information. The network topology information may include tenant attribute mapping information, which maps the tenant attributes to a tenant identifier and a particular port and switch to which the new host has connected. Although the DHCP server 144 is shown as within the network 102, in some embodiments, the DHCP server 144 may be located in a different network.

Following initializing, the new host may transmit a DHCP message in broadcast form, to which the DHCP server 144 responds once received. Prior to the DHCP message arriving at the DHCP server 144, the DHCP message may be received by a DHCP relay agent. Each DHCP relay agent 134, 136, and 137 may be programmed on each of the switches 114, 116, and 117. Each DHCP relay agent 134, 136, and 137 is configured to obtain and augment a DHCP message from a host, convert the broadcast message into unicast form, and forward the augmented DHCP message to a DHCP server 144. As will be described in further detail, the augmenting of the DHCP message may include augmenting, onto a field of the DHCP message, tenant attribute information of a particular tenant associated with a host that transmitted the DHCP message. The DHCP relay agent 134 obtains and augments DHCP messages from the hosts 104 and 105. The DHCP relay agent 136 obtains and augments DHCP messages from the host 106. The DHCP relay agent 137 obtains and augments DHCP messages from the host 107. In some embodiments, the DHCP relay agents 134, 136, and 137 may each be programmed within a respective VLAN interface.

For an already initialized host, after receiving an augmented DHCP message from the DHCP relay agent (e.g., any of the DHCP relay agents 134, 136, 137), the DHCP server 144 is configured to identify the tenant associated with the host that transmitted the DHCP message. Because the augmented DHCP message already contains the tenant attribute information, the DHCP server 144 may retrieve the network topology information to derive an identity of the tenant from the tenant attribute information. If the augmented DHCP message did not include the tenant attribute information, then the DHCP server 144 would be unable to derive the identity of the tenant.

In some embodiments, upon identifying the tenant, the DHCP server 144 is configured to assign an IP address (e.g., an IPv4 or an IPv6 address) based on tenant IP address information. In some embodiments, tenant IP address information includes IP address subranges allocated to each tenant and any rules for allocating of IP address subranges or assigning of IP addresses to tenants. Here, allocation may refer to setting of a range of permitted IP addresses while assigning may refer to selecting a specific address within the range. In some embodiments, the DHCP server 144 is configured to provision tenant configuration parameters for the host, in response to identifying the tenant associated with the host. In some embodiments, tenant configuration parameters include any or all of a subnet mask (e.g., to distinguish a portion of the IP address corresponding to the network from a portion of the IP address corresponding to the specific host), a default gateway (e.g., the IP address of the router 172), Domain Name System (DNS) server IP addresses, a hostname (e.g., a name of the host), a domain name, and a search domain name.

In some embodiments, a DHCP database 154 may store the network topology information and the tenant IP address information. In some embodiments, the DHCP database 154 may be implemented according to a relational database management system (RDBMS), a MySQL relational database system, an object-based database system, or the like. In some embodiments, the DHCP database 154 may include a monolithic database to store the network topology information and the tenant IP address information in one or more data formats, such as structured formats. In some embodiments, the network topology information and the tenant IP address information may be normalized into a structured format prior to storage in the DHCP database 154. As used herein, formats may include data types, variable types, protocols (e.g., protocols for accessing, storing, and/or transmitting data), programming languages, scripting languages, data value parameters (e.g., date formats, string lengths), endpoint locations or types, schemas, or the like. In some embodiments, the DHCP database 154 may include one or more virtual stores, such as cloud-based stores. The DHCP database 154 may store data as objects within buckets, which are containers for the objects. Each of the objects may be linked to a key which uniquely identifies an object. The objects may contain object data and metadata. The metadata may include a set of name-value pairs that describe each object. In some embodiments, the DHCP database 154 may include directories that partition data (e.g., files) for easier access and retrieval. For example, the partitions may be based on different tenants or types of data (e.g., the network topology information and the tenant IP address information)

In some embodiments, a DHCP controller 164 may manage one or more operations of the DHCP server 144, such as initializing a new host. In some embodiments, although the DHCP database 154, the DHCP server 144, and the DHCP controller 164, are shown separately, the separation is shown as merely an example of different aspects of the DHCP server system. Any of the DHCP database 154, the DHCP server 144, and the DHCP controller 164 may be integrated together. In some embodiments, the DHCP server system may include the DHCP server 144 and one or more of the DHCP relay agents 134, 136, and 137.

FIG. 1B is a block diagram illustrating further details of the network system 100 illustrated in FIG. 1A, in accordance with some embodiments of the present invention. FIG. 1B may be implemented in conjunction with FIG. 1A. In FIG. 1B, the network 102 may include multiple layers of switches, such as an access layer 110 and a core layer 190 that connects the switches within the access layer 110 for additional redundancy and guaranteed number of hops while reducing a number of ports on each switch. The multiple layers of switches increase resistance to failure, such that remaining switches may continue to operate in an event of failure of any of the switches. The core layer 190 may be directly or indirectly connected to the router 172. In some embodiments, the access layer 110 includes the switches 114, 116, and 117 as illustrated in FIG. 1A. In some embodiments, the core layer 190 includes switches 194 and 196. Each switch within the access layer 110 may be directly connected to each of the switches 194 and 196 within the core layer 190. In some embodiments, the access layer 110 and the core layer 190 may be implemented as a Clos network, such as a spine-leaf network, wherein each of switches 114, 116 and 117 is a leaf and each of switch 194 and 196 is a spine.

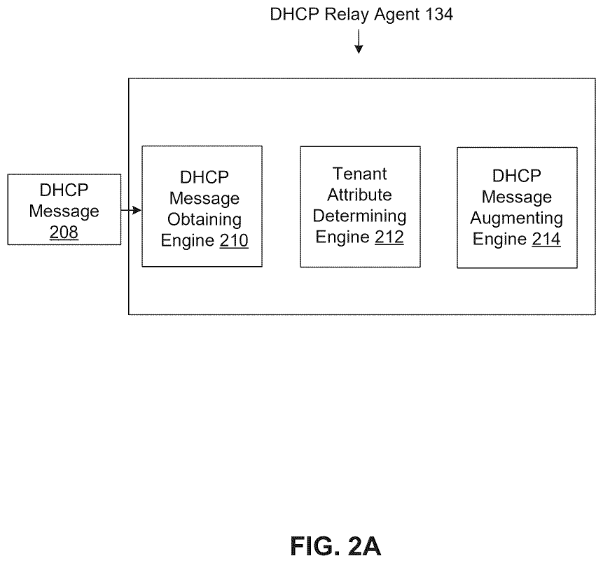

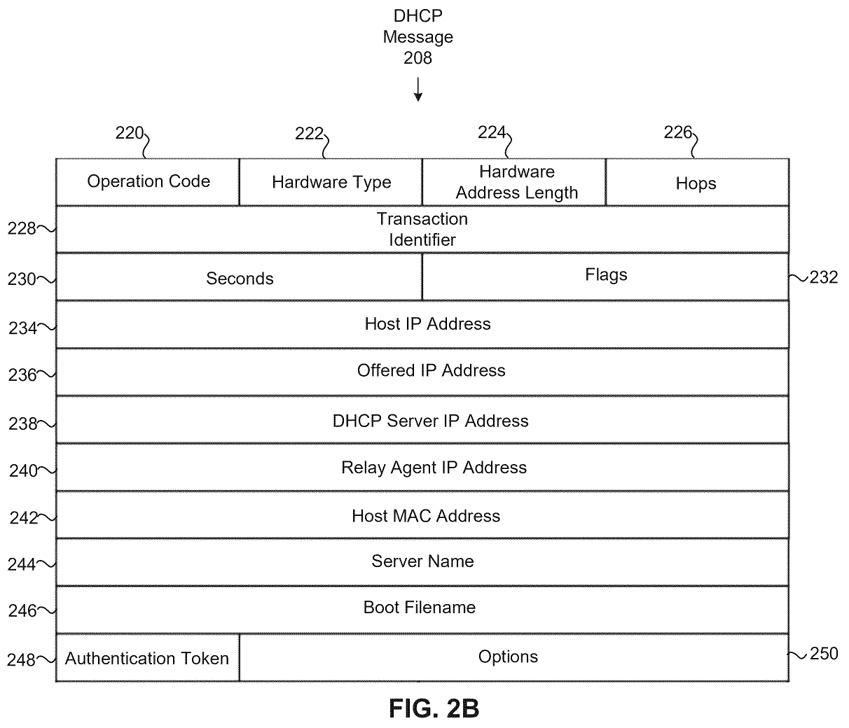

FIG. 2A is a block diagram illustrating details of the DHCP relay agent 134 within the DHCP server system, in accordance with some embodiments of the present invention. Principles described for the DHCP relay agent 134 may also be applicable to the other DHCP relay agents 136 and 137. The DHCP relay agent 134 may include a DHCP message obtaining engine 210, a tenant attribute determining engine 212, and a DHCP message augmenting engine 214. Although the foregoing describes the DHCP message obtaining engine 210, the tenant attribute determining engine 212, and the DHCP message augmenting engine 214 separately for ease of understanding, the invention is not to be construed as limited to such. In some embodiments, any of the aforementioned engines may be integrated.

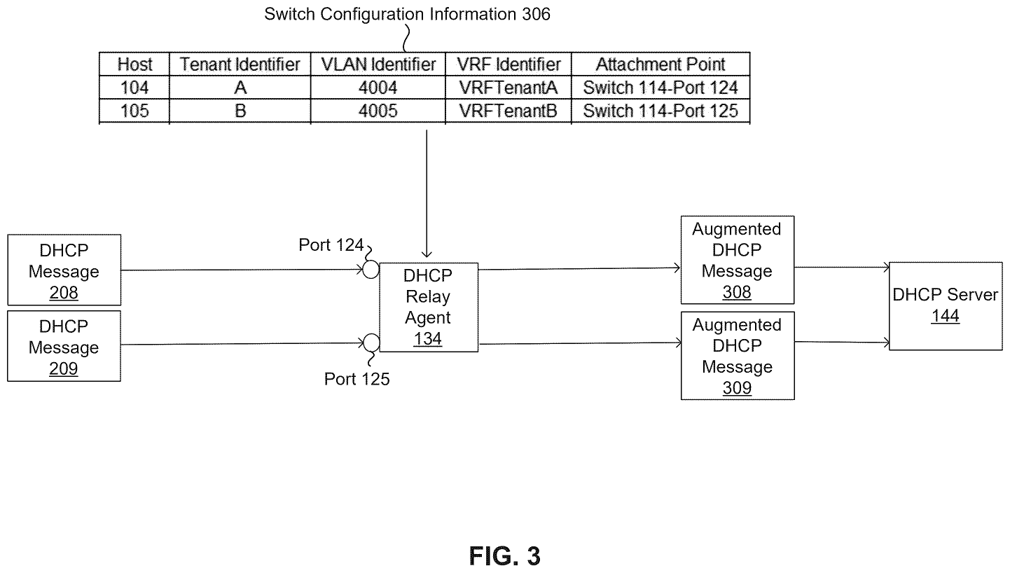

The DHCP message obtaining engine 210 includes hardware, software and/or firmware configured to obtain a DHCP message 208 transmitted by a host (e.g., the host 104). In some embodiments, the DHCP message 208 may include a DHCP discover message or a DHCP request message. As illustrated in FIG. 3, the DHCP message obtaining engine 210 may obtain the DHCP message 208 through a VLAN interface assigned to the port 124, which the host 104 is connected to. The DHCP message 208 may include a packet with fields. An example of the DHCP message 208 is illustrated in FIG. 2B.

The tenant attribute determining engine 212 includes hardware, software and/or firmware configured to determine one or more tenant attributes of a tenant to which the host 104 belongs. In some embodiments, the tenant attributes include either or both of a VLAN identifier and a VRF identifier. In some embodiments, the tenant attribute determining engine 212 may determine the VLAN identifier directly from the VLAN or the VLAN interface assigned to the port 124, within which the DHCP message 208 was transmitted. In some embodiments, the tenant attribute determining engine 212 may obtain an IP address of the VLAN interface and determine the VLAN identifier corresponding to the IP address of the VLAN interface. In some embodiments, the VLAN identifier may refer to a circuit identifier and identify the VLAN interface assigned to the port 124. In some embodiments, the VLAN identifier includes the name of the VLAN interface and the name of the VLAN.

In some embodiments, the tenant attribute determining engine 212 may determine the VRF identifier based on the VLAN identifier and switch configuration information of the switch 114, as illustrated in FIG. 3. The switch configuration information may contain a subset of network topology information which may be stored within the DHCP server 144 or the DHCP database 154. The switch configuration information may have been transmitted by the DHCP server 144 during initialization of the host 104. The switch configuration information may map the tenant attribute information of the host 104 to host connection information. The host connection information may include an attachment point of the host 104 at a particular port (e.g., the port 124) and a particular switch (e.g., the switch 114). In some embodiments, the tenant attribute determining engine 212 may determine the port 124 through which the DHCP message 208 has been transmitted based on the VLAN identifier, due to a one-to-one mapping between each VLAN identifier and each port. Here, because the tenant attribute determining engine 212 has determined the VLAN identifier, the tenant attribute determining engine 212 also determines the host connection information that the DHCP message 208 has been transmitted through the port 124. Therefore, the tenant attribute determining engine 212 may derive the VRF identifier based on the switch configuration information. In some embodiments, the VRF identifier may refer to or identify a virtual subnet assigned to the host 104. The tenant attributes, once determined, are added to the DHCP message augmenting engine 214 to augment the DHCP message 208.

The DHCP message augmenting engine 214 includes hardware, software and/or firmware configured to augment the DHCP message 208, without additional code on the host 104, the DHCP server 144, or the DHCP relay agent 134. In some embodiments, augmenting the DHCP message 208 may include adding tenant attribute information in one or more fields of the DHCP message 208, such as a tenant attribute field of the DHCP message 208. In some embodiments, the tenant attribute field may be located within a header of the DHCP message 208. The DHCP message augmenting engine 214 may add one or both of the VLAN identifier and the VRF identifier corresponding to the host 104 that transmitted the DHCP message 208. In some embodiments, the VLAN identifier and the VRF identifier correspond to DHCP Option 82. In some embodiments, the VLAN identifier and the VRF identifier correspond to DHCP SubOption 1 and SubOption 152. The DHCP message augmenting engine 214 may refrain from informing the host 104 that the DHCP message 208 is being augmented. In fact, the host 104 never receives any indication that the DHCP message 208 has been augmented or that the DHCP server 144 supports multi-tenancy. The host 104 still maintains the same experience as though the host 104 were communicating with its own dedicate DHCP server.

By adding one or both of the VLAN identifier and the VRF identifier into the tenant attribute field, the DHCP message augmenting engine 214 makes the DHCP server 144 aware of the tenant attributes of the host 104, so that the DHCP server 144 identifies the tenant to which the host 104 belongs. The DHCP server 144 would then be able to support multi-tenancy within the network 102. Otherwise, if the VLAN identifier and the VRF identifier were not added to the DHCP message 208, this tenant attribute information would not be transmitted to the DHCP server 144. Then, the DHCP server 144 would be unaware of the tenant attribute information and be unable to identify the tenant. Without being able to identify the tenant, the DHCP server 144 would be unable to support multi-tenancy within the network 102. Without this identification, the DHCP server 144 would be unable to determine what tenant the DHCP message 208 is coming from, and unable to determine an allocated IP address subspace, specific for the tenant, or network configuration parameters required for the tenant.

FIG. 2B is a diagram illustrating the DHCP message 208. The DHCP message 208 may include fields 220, 222, 224, 226, 228, 230, 232, 234, 236, 238, 240, 242, 244, 246, 248, and 250. In some embodiments, the fields 220, 222, 224, 226, 228, 230, 232, 234, 236, 238, 240, 242, 244, 246, 248, and 250 may be implemented within a header of the DHCP message 208. Fewer, more or different fields are also contemplated. Because the DHCP message 208 may initially be a broadcast message as opposed to a unicast message, then some of the fields such as the fields 236, 238, 240, 242, and 244, may be empty or contain null entries.

The field 220 may specify an operation code which identifies a type of message. Here, the operation code may specify that the DHCP message 208 is a request or discover message originating from the host 104, and the operation code in the field 220 may be 0x01 to indicate a request or discover message. However, in other embodiments, if a DHCP message is a response or acknowledgement message originating from the DHCP server 144, then the operation code may have a value of 0x02 to specify that the DHCP message 208 is a response or acknowledgement message.

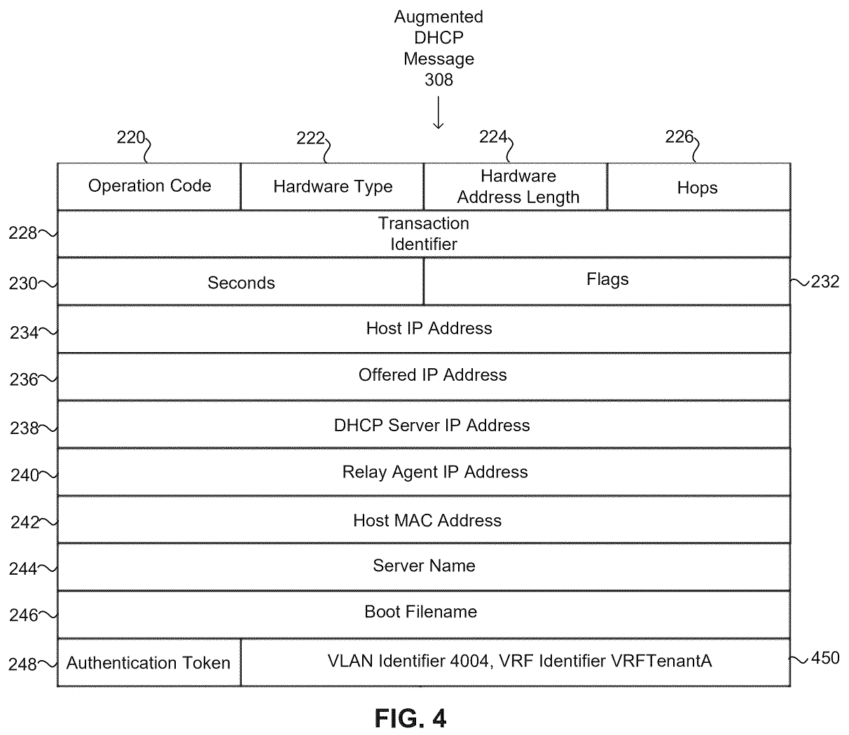

The field 222 may specify a hardware type which identifies a type of Layer 2 protocol through which the host 104 is connected to the DHCP server 144. Examples of Layer 2 protocols include Ethernet and 802.11x. The field 224 may specify a length, in bytes, of the field 222. The field 226 may specify a number of hops the DHCP message 208 can travel before being discarded. In some embodiments, each hop counted may correspond to traveling across one router. The field 228 may specify a transaction identifier, which may be an arbitrary identifier to identify the host 104. The field 230 may specify an elapsed time since the host 104 transmitted the DHCP message 208. If the elapsed time exceeds a threshold time, then the DHCP server 144 may cancel an offer for an IP address, because the host 104 did not accept the offer within the threshold time, and the IP address may be returned to an IP pool for future allocation for that specific tenant. The field 232 may specify whether the DHCP message 208 is a broadcast or a unicast message. The field 234 may specify an IP address of the host 104 or alternatively, a source IP address. Before the host 104 has been assigned an IP address, the field 234 may specify a value of 0.0.0.0, so that the DHCP message 208 is transmitted via Layer 3 communications. The field 236 may specify an IP address that is offered by the DHCP server 144 to the host 104. The field 238 may specify an IP address of the DHCP server 144. In some embodiments, the field 238 may further specify a local network broadcast address of 255.255.255.255 because the actual IP address of the DHCP server 144 is unknown. This enables the DHCP message 208 to be transmitted via Layer 3 communications. The field 240 may specify an IP address of the DHCP relay agent through which the DHCP message 208 is being routed (e.g., the DHCP relay agent 134). The field 242 may specify a Media Access Control (MAC) address of the host 104, or alternatively, the source MAC address. The field 244 may specify a name of the DHCP server 144. The field 246 may specify a boot filename, which may include a particular type of boot file requested in a DHCP discover message. The field 248 may include an authentication token to authenticate the DHCP message 208 at the DHCP server 144. The field 250 may specify contextual information of the DHCP message 208. In some embodiments, the field 250 may include a tenant attribute field. In some embodiments, the tenant attribute field is being augmented by the DHCP relay 134, as illustrated in FIG. 4.

FIG. 3 is a diagram illustrating an example implementation of the DHCP relay agent 134, in which the DHCP relay agent 134 augments multiple DHCP messages transmitted from different hosts belonging to different tenants. In FIG. 3, the DHCP relay agent 134 may obtain the DHCP message 208 from a VLAN interface, which may be a virtual interface that communicates DHCP messages from the host 104 to the DHCP relay agent 134. The DHCP relay agent 134 recognizes that the DHCP message 208 has been transmitted through a VLAN corresponding to the VLAN interface. Therefore, the DHCP relay agent 134 may determine a VLAN identifier of the host 104 from the VLAN interface, such as from an IP address of the VLAN interface. In some embodiments, a unique VLAN interface may communicate DHCP messages from each different host.

The DHCP relay agent 134 may determine a VRF identifier of the host 104 based on the VLAN identifier and switch configuration information 306. In some embodiments, the switch configuration information 306 may be stored within, or associated with, the switch 114, and retrieved by the DHCP relay agent 134. The switch configuration information 306 may have been previously obtained from the DHCP server 144 following initialization of the host 104 and transmitted to the switch 114 or the DHCP relay agent 134. In some embodiments, the switch configuration information 306 may encompass a relevant subset of network topology information, in particular, for the hosts that are connected to the switch 114. Thus, network topology information of other hosts 106 and 107 connected to the switches 116 and 117 may be excluded from the switch configuration information 306.

The switch configuration information 306 may map a relationship between the tenant attributes and host connection information, which may include an attachment point (e.g., a particular switch and a particular port to which the host is connected on the switch). In some embodiments, although included in FIG. 3 for the sake of illustration, the switch configuration information 306 may exclude tenant identifier information, which identifies tenant identifiers A and B and maps them to the hosts 104 and 105.

The DHCP relay agent 134 may determine the attachment point of the host 104 based on a mapping between the VLAN identifier and the attachment point of the host 104. In some embodiments, the DHCP relay agent 134 is aware of a one-to-one mapping between the VLAN identifier and the attachment point, as a different VLAN corresponds to each different port, and vice versa. Once the DHCP relay agent 134 has determined the VLAN identifier and the attachment point of the host 104, the DHCP relay agent 134 may derive the VRF identifier. In the switch configuration information 306, there is only one VRF identifier that has the determined VLAN identifier and the attachment point of the host 104.

Upon determining the tenant attributes for the host 104, the DHCP relay agent 134 may augment the DHCP message 208 with the tenant attributes and generate an augmented DHCP message 308. The DHCP relay agent 134 may transmit the augmented DHCP message 308 to the DHCP server 144. In some embodiments, the DHCP relay agent 134 may convert the broadcasted DHCP message 208 into a unicast form. The DHCP relay agent 134 may also modify other fields of the DHCP message 208, such as the source IP address field, the source MAC address field, and the destination IP address field. The source IP address field and the Source MAC address field may be modified to that of the DHCP relay agent 134 and the destination IP address field may be modified to that of the DHCP server 144.

In an analogous manner, the DHCP relay agent 134 obtains a DHCP message 209 from the host 105, which is connected to the port 125. In the example illustrated here, the host 105 belongs to a different tenant compared to the host 104. The DHCP relay agent 134 may determine the tenant attributes corresponding to the host 105 using the switch configuration information 306 and augment the DHCP message 209 with the determined tenant attributes. The DHCP relay agent 134 may generate an augmented DHCP message 309. The DHCP relay agent 134 may transmit the augmented DHCP message 309 to the DHCP server 144. In some embodiments, the DHCP relay agent 134 may perform augmenting of numerous DHCP messages from different tenants at least partially concurrently. Upon receiving the augmented DHCP messages, the DHCP server 144 may assign IP addresses based on allocated IP address subspaces that may be at least partially overlapping to the different hosts belonging to different tenants.

FIG. 4 is a diagram illustrating the augmented DHCP message 308, and includes the fields previously described in FIG. 2B. FIG. 4 illustrates that tenant attribute field 450 (corresponding to the field 250 in FIG. 2B) has been modified by the DHCP relay agent 134 to include the tenant attribute information, which may encompass one or both of the VLAD identifier and the VRF identifier for the host 104. In some embodiments, as mentioned in FIG. 3, the DHCP relay agent 134 converts the DHCP message 308, previously in broadcast form, to a unicast form message. In some embodiments, the DHCP relay agent 134 modifies or adds to other fields. For example, the DHCP relay agent 134 may modify the field 238 to include an actual IP address of the DHCP server 144. The DHCP relay agent 134 may modify the fields 234 and 240 to its own IP address. The DHCP relay agent 134 may modify the field 242 to its own MAC address.

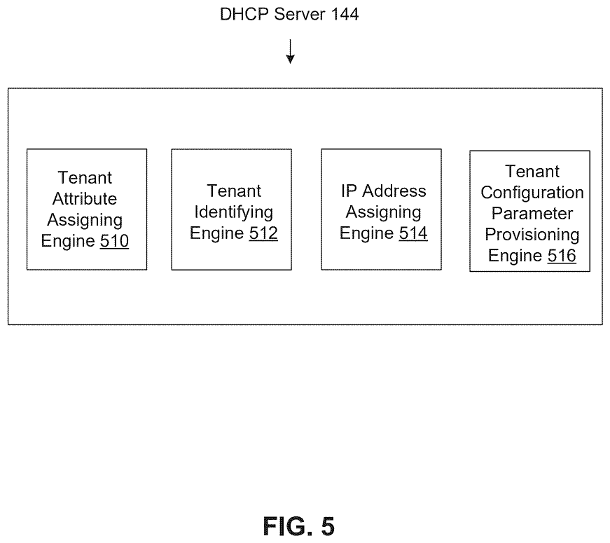

FIG. 5 is a block diagram illustrating details of the DHCP server 144 within the DHCP server system, in accordance with some embodiments of the present invention. The DHCP server 144 may include a tenant attribute assigning engine 510, a tenant identifying engine 512, an IP address assigning engine 514, and a tenant configuration parameter provisioning engine 516.

Although the foregoing describes the tenant attribute assigning engine 510, the tenant identifying engine 512, the IP address assigning engine 514, and the tenant configuration parameter provisioning engine 516 separately for ease of understanding, the invention is not to be construed as limited to such. In some embodiments, any of the aforementioned engines may be integrated.

The tenant attribute assigning engine 510 includes hardware, software and/or firmware configured to initialize a new host upon detecting that the new host (e.g., the host 104) has joined the network 102, and prior to the new host transmitting a DHCP message or requesting an IP address. In some embodiments, initializing the new host may include assigning tenant attributes to the new host. The tenant attributes may include a VLAN identifier (e.g., 4004) and a VRF identifier (e.g., VRFTenantA). More generally, for each subnet that is provisioned for a tenant, the tenant attribute assigning engine 510 assigns a unique combination of the VLAN identifier and the VRF identifier. The tenant attribute assigning engine 510 may also update the network topology information (e.g., stored in the DHCP database 154). The updates may include the newly assigned VLAN identifier and the VRF identifier, which may be mapped to a tenant identifier (e.g., “A”) and an attachment point (e.g., switch 114 and port 124) at which the new host has connected. In some embodiments, the tenant attribute assigning engine 510 may allocate one or more IP address subspaces (e.g., ranges of permitted IP addresses) corresponding to the tenant.

The tenant identifying engine 512 includes hardware, software and/or firmware configured to, after obtaining a DHCP message (e.g., a DHCP discover message) from the new host, identify the tenant to which the new host belongs. In some embodiments, the tenant identifying engine 512 may be part of a control plane. Because the tenant identifying engine 512 obtains an augmented DHCP message (e.g., 308) from the DHCP relay agent 134, the tenant identifying engine 512 may extract the tenant attribute information from the augmented DHCP message which includes the VLAN identifier and the VRF identifier. By retrieving the network topology information from the DHCP database 154 which was previously updated with the tenant identifier mapped to the VLAN identifier and the VRF identifier, the tenant identifying engine 512 may identify the tenant as “A.”

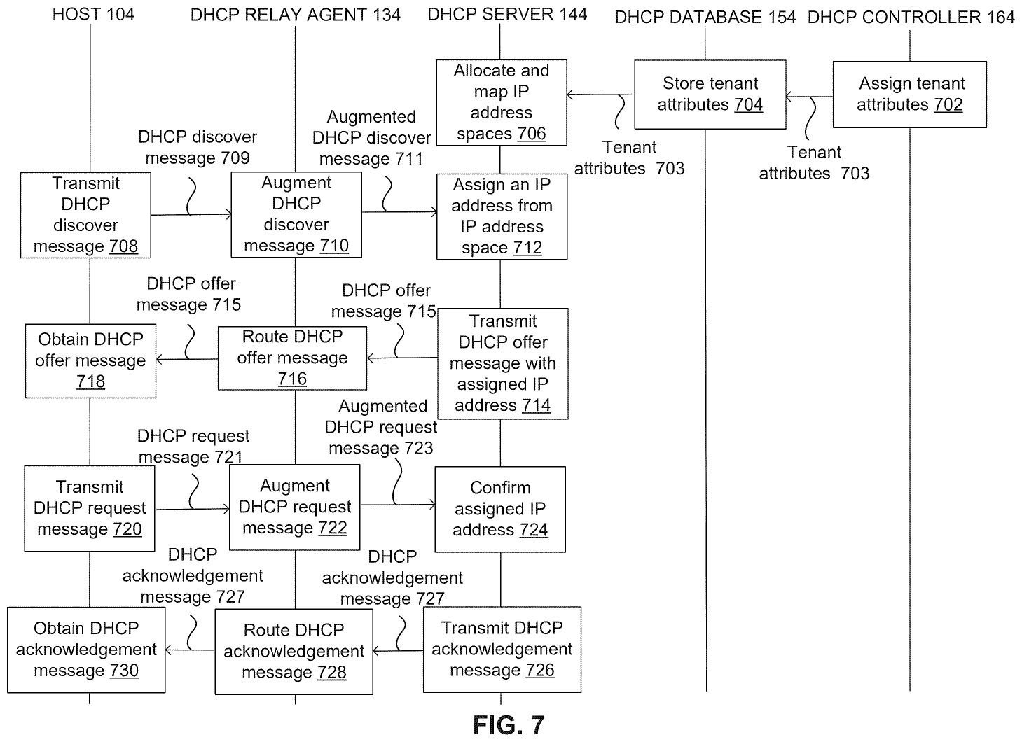

The IP address assigning engine 514 includes hardware, software and/or firmware configured to assign an IP address in response to identifying the tenant. The IP address assigning engine 514 may determine a permitted IP address subrange based on tenant IP address information, which may be stored in the DHCP database 154. In some embodiments, the IP address assigning engine 514 may select an IP address in accordance with the permitted IP address subrange and output an offer (e.g., a DHCP offer message) with the selected IP address. The assigning process may encompass an offer, a request, and an acknowledgement, as further described in FIG. 7. The IP address assigning engine 514 may transmit the DHCP offer message to the DHCP relay agent 134 in unicast form because the IP address assigning engine 514 obtained the IP address of the DHCP relay agent 134 from the augmented DHCP message 308. Upon receiving a DHCP request message, the IP address assigning engine 514 may transmit a DHCP acknowledgement message to the DHCP relay agent 134 in unicast form.

The tenant configuration parameter provisioning engine 516 includes hardware, software and/or firmware configured to provision, program, or set tenant configuration (e.g., IP-related) parameters, which may be unique for each tenant even if some tenants share overlapping IP address subspaces. In some embodiments, provisioning may include managing the assigned IP addresses (e.g., tracking or recording a duration and remaining lease, or any flags associated with the assigned IP addresses) or managing the tenant configuration parameters. In some embodiments, tenant configuration parameters include any or all of a subnet mask (e.g., to distinguish a portion of the IP address corresponding to the network from a portion of the IP address corresponding to the specific host), a default gateway (e.g., the IP address of the router 172), Domain Name System (DNS) server IP addresses, a hostname (e.g., a name of the host), a domain name, and a search domain name. In some embodiments, other tenant configuration parameters may specify particular IP address parameters include a lease time (e.g., how long an IP address is valid before requiring renewal).

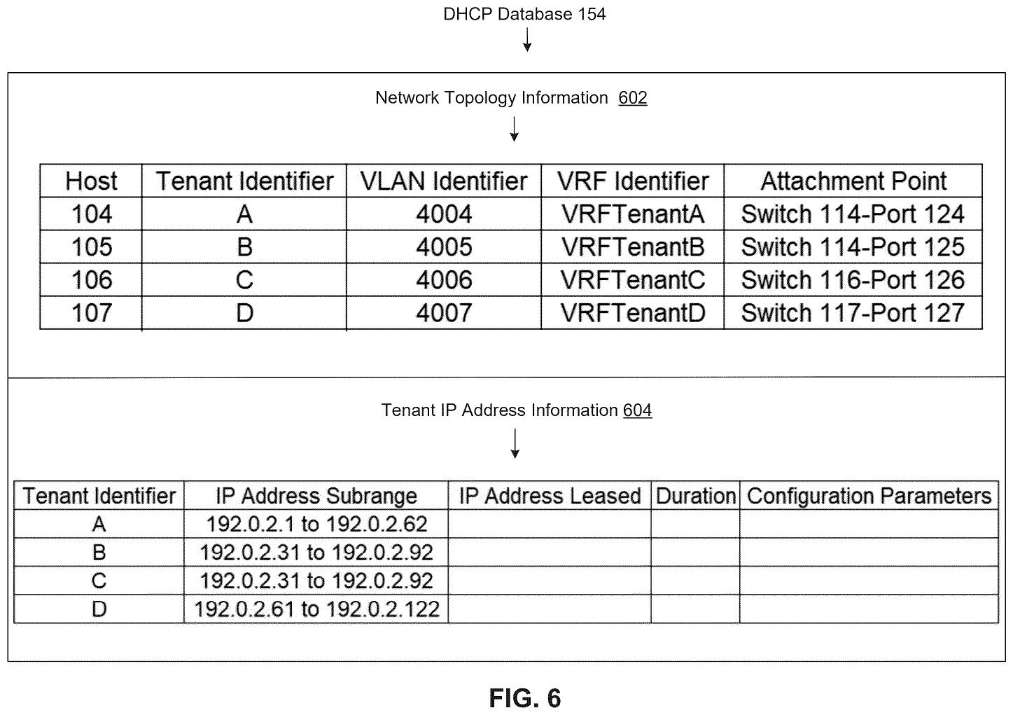

FIG. 6 is a block diagram illustrating details of a DHCP database within the DHCP server system, in accordance with some embodiments of the present invention. In FIG. 6, the DHCP database 154 may store network topology information 602, which includes tenant attributes belonging to different tenants, attachment points of the different tenants, and hosts associated with the different tenants. In some embodiments, the network topology information 602 is continuously updated every time a new host connects to the network 102. In some embodiments, relevant subsets of the network topology information 602 may be transmitted to each switch or each DHCP relay agent to be stored as switch configuration information (e.g., switch configuration information 306). For example, relevant subsets may include network topology information for the hosts that are connected to a port of each switch. Thus, the network topology information of hosts 104 and 105 may be transmitted to the switch 114, but not transmitted to the switches 116 and 117. The network topology information of host 106 may be transmitted to the switch 116, but not transmitted to the switches 114 and 117. The network topology information of host 107 may be transmitted to the switch 117, but not transmitted to the switches 114 and 116.

The DHCP database 154 may further include tenant IP address information 604, which includes one or more protocols or restrictions for allocating of IP addresses or IP address subranges to different tenants. The protocols may define, without limitation, permitted IP address subranges, lease times, and excluded IP addresses. In some embodiments, the tenant IP address information may include, additionally or alternatively, current IP addresses leased to each tenant, a remaining duration prior to renewal of each of the current IP addresses, and other IP address configuration parameters. The DHCP database 154 may be accessed by the DHCP server 144 in order to identify a particular tenant that has broadcasted a DHCP message, assign an IP address to the identified tenant, and provision tenant configuration parameters.

FIG. 7 is a flowchart of a method of assigning internet protocol (IP) addresses and provisioning host tenant configuration parameters while supporting multi-tenancy, in accordance with some embodiments of the present invention. In step 702, the DHCP controller 164, which may be implemented as part of the DHCP server 144, may, upon detecting a new host in the network 102, assign tenant attributes 703 to the new host. The tenant attributes may include a VLAN identifier and a VRF identifier for the new host. Assigning of the tenant attributes includes ensuring that each different tenant has a unique combination of VLAN identifier and VRF identifier. In step 704, the tenant attributes 703 may be stored, for example, within the network topology information 602 of the DHCP database 154. The tenant attributes 703 may be received at the DHCP server 144. In step 706, the DHCP server 144 may allocate IP address subspaces for the new host and map the allocated IP address subspaces to the tenant attributes. The allocated IP address subspaces may be stored as part of the tenant IP address information 604 in the DHCP database 154. By storing the allocated IP address subspaces, the DHCP server 144 may retrieve the relevant allocated IP address subspaces upon identifying a particular tenant that has transmitted a DHCP message.

In step 708, the host 104 may transmit a DHCP discover message 709 which may be implemented as the DHCP message 208. In some embodiments, the DHCP discover message 709 may include a User Datagram Protocol (UDP) packet encapsulated within an IP packet, which is encapsulated within an Ethernet frame. The DHCP discover message 709 may be in broadcast form, with a source IP address of 0.0.0.0 with a destination IP address of 255.255.255.255. The DHCP discover message 709 may be transmitted over Layer 3 communications. In step 710, the DHCP relay agent 134 may intercept the DHCP discover message 709 and augment the DHCP discover message with tenant attribute information in a tenant attribute field. The DHCP relay agent 134 may further convert the DHCP discover message 709 into a unicast form, while replacing other fields of the DHCP discover message such as a source IP address, a source MAC address, and a destination IP address. The DHCP relay agent 134 may generate an augmented DHCP discover message 711 (which may be in unicast form) and transmit the augmented DHCP discover message 711 to the DHCP server 144. In step 712, the DHCP server 144 may identify the tenant that transmitted the DHCP discover message 709 by extracting the tenant attribute information from the augmented DHCP discover message 711. The DHCP server 144 may assign an IP address according to the allocated IP address subspace for the identified tenant.

In step 714, the DHCP server 144 may transmit a DHCP offer message 715 that includes the assigned IP address. The DHCP server 144 may transmit the DHCP offer message 715 in unicast form because the DHCP server 144 knows the destination IP address of the DHCP relay agent 134. Once the DHCP offer message 715 is received by the DHCP relay agent 134, the DHCP relay agent 134, in step 716, may route the DHCP offer message 715 to the host 104. In some embodiments, the DHCP relay agent 134 transmits the DHCP offer message 715 in unicast form with the offered IP address being the destination IP address. In other embodiments, depending on a broadcast flag field of the DHCP offer message 715, the DHCP relay agent 134 transmits the DHCP offer message 715 in broadcast form.

In step 718, the host 104 obtains the DHCP offer message. In step 720, the host 104, within a permitted time frame, transmits a DHCP request message 721 signifying an acceptance of the offered IP message in broadcast form. The DHCP request message 721 may be implemented as the DHCP message 208. In some embodiments, the DHCP request message 721 may include a User Datagram Protocol (UDP) packet encapsulated within an IP packet, which is encapsulated within an Ethernet frame. The DHCP relay agent 134 intercepts the DHCP request message 721, augments the DHCP request message 721 in step 722 to include the tenant attribute information. Augmented DHCP request message 723 may be in unicast form. The DHCP relay agent 134 transmits the augmented DHCP request message 723 to the DHCP server 144 in unicast form.

In step 724, the DHCP server 144 confirms a validity of the augmented DHCP request message 723 (e.g., that the augmented DHCP request message 723 was received within a permitted range of time). In step 726, the DHCP server 144 transmits a DHCP acknowledgement message 727 to the DHCP relay agent 134 in unicast form. In step 728, the DHCP relay agent 134 routes the DHCP acknowledgement message 727 to the host 104. In some embodiments, the DHCP relay agent 134 transmits the DHCP acknowledgement message 727 in unicast form with the acknowledged IP address being the destination IP address. In other embodiments, depending on a broadcast flag field of the DHCP acknowledgement message 727, the DHCP relay agent 134 transmits the DHCP acknowledgement message 727 in broadcast form. In step 730, the host obtains the DHCP acknowledgement message 727

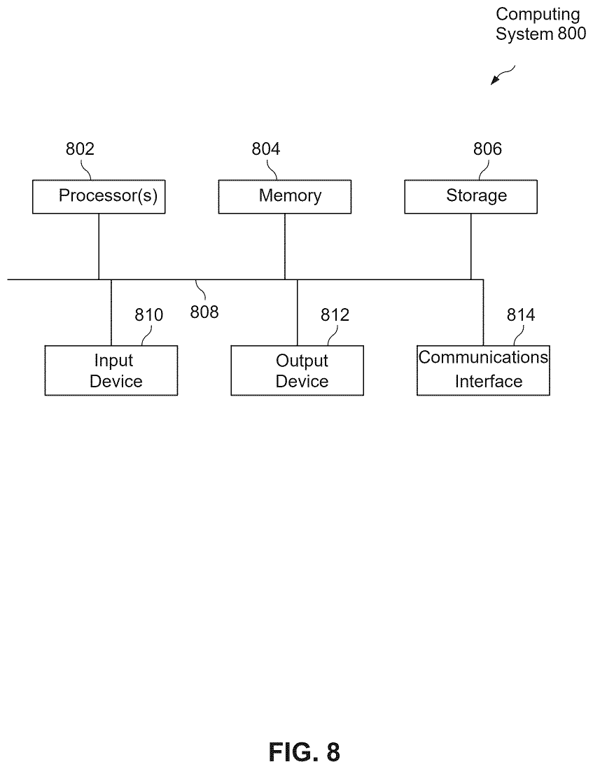

FIG. 8 is a block diagram of a computing device 800. Any of the systems, engines, datastores, and/or networks described herein may comprise an instance of one or more computing devices 800. In some embodiments, functionality of the computing device 800 is improved to perform some or all of the functionality described herein. The computing device 800 comprises a processor 812, memory 814, storage 816, an input device 820, a communication network interface 824, and an output device 822 communicatively coupled to a communication channel 818. The processor 812 is configured to execute executable instructions (e.g., programs). In some embodiments, the processor 812 comprises circuitry or any processor capable of processing the executable instructions.

The memory 814 stores data. Some examples of memory 814 include storage devices, such as RAM, ROM, RAM cache, virtual memory, etc. In various embodiments, working data is stored within the memory 814. The data within the memory 814 may be cleared or ultimately transferred to the storage 816.

The storage 816 includes any storage configured to retrieve and store data. Some examples of the storage 816 include flash drives, hard drives, optical drives, cloud storage, and/or magnetic tape. In some embodiments, storage 816 may include RAM. Each of the memory 814 and the storage 816 comprises a computer-readable medium, which stores instructions or programs executable by processor 812.

The input device 820 may be any device that inputs data (e.g., mouse and keyboard). The output device 822 may be any device that outputs data and/or processed data (e.g., a speaker or display). It will be appreciated that the storage 816, input device 820, and output device 822 may be optional. For example, the routers/switchers may comprise the processor 812 and memory 814 as well as a device to receive and output data (e.g., the communication network interface 824 and/or the output device 822).

The communication network interface 824 may be coupled to a network (e.g., the network system 100) via the link 818. The communication network interface 824 may support communication over an Ethernet connection, a serial connection, a parallel connection, and/or an ATA connection. The communication network interface 824 may also support wireless communication (e.g., 802.11 a/b/g/n, WiMax, LTE, WiFi). It will be apparent that the communication network interface 824 may support many wired and wireless standards.

It will be appreciated that the hardware elements of the computing device 800 are not limited to those depicted. A computing device 800 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 812 and/or a co-processor located on a GPU (i.e., NVidia).

It will be appreciated that an “engine,” “system,” “datastore,” and/or “database” may comprise software, hardware, firmware, service, microservice, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance. It will be appreciated that the term “request” shall include any computer request or instruction, whether permissive or mandatory.

The databases/datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise. References to objects may refer to data representations that include fields and/or attributes that define the data.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Reference to A “and” B may be construed to also encompass the scenario of A “or” B. Reference to A “or” B may be construed to also encompass the scenario of A “and” B. Any reference to “near,” a “threshold” or “sufficiency” may be construed to encompass any applicable value or degree, such as any applicable value or degree sufficient to satisfy a given outcome. In some examples, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity, degree, or level may be construed as qualitatively satisfying some condition.

The phrases “at least one of,” “at least one selected from the group of,” or “at least one selected from the group consisting of,” and the like are to be interpreted in the disjunctive (e.g., not to be interpreted as at least one of A and at least one of B).

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A multi-tenant Dynamic Host Configuration Protocol (DHCP) server system comprising a DHCP relay agent and a DHCP server, the DHCP server system comprising one or more hardware processors memory storing computer instructions, the computer instructions when executed by the one or more hardware processors configured to perform:
in a first process:
obtaining, by the DHCP relay agent, a first broadcasted DHCP message from a first host within a first Virtual Local Area Network (VLAN);
determining, by the DHCP relay agent, first tenant attribute information of the first host based on switch configuration information;
augmenting, by the DHCP relay agent, the first broadcasted DHCP message with the determined first tenant attribute information;
converting, by the DHCP relay agent, the first broadcasted DHCP message to a unicast form; and
transmitting, by the DHCP relay agent, the unicast augmented first DHCP message to the DHCP server;
in a second process:
obtaining, by the DHCP relay agent, a second broadcasted DHCP message from a second host within a second VLAN;
determining, by the DHCP relay agent, second tenant attribute information of the second host based on the switch configuration information;
augmenting, by the DHCP relay agent, the second broadcasted DHCP message with the determined second tenant attribute information;
converting, by the DHCP relay agent, the second broadcasted DHCP message to a unicast form; and
transmitting, by the DHCP relay agent, the unicast augmented second DHCP message to the DHCP server; and
in a third process:
identifying, based on the unicast augmented first DHCP message, by the DHCP server, a first tenant associated with the first host;
identifying, based on the unicast augmented second DHCP message, by the DHCP server, a second tenant associated with the second host;
assigning, by the DHCP server, a first Internet Protocol (IP) address to the first host from a first allocated subspace of IP addresses for the first tenant and a second IP address to the second host from a second allocated subspace of IP addresses for the second tenant; and
provisioning first tenant configuration parameters for the first host and second tenant configuration parameters for the second host.

2. The DHCP server system of claim 1, wherein the first allocated subspace and the second allocated subspace are at least partially overlapping.

3. The DHCP server system of claim 1, wherein the first tenant attribute information comprises a first VLAN identifier and a first Virtual Routing and Forwarding (VRF) identifier which identifies a first routing instance for the first broadcasted DHCP message, and the second tenant attribute information comprises a second VLAN identifier and a second VRF identifier which identifies a second routing instance for the second broadcasted DHCP message.

4. The DHCP server system of claim 3, wherein the switch configuration information comprises a first mapping between the first tenant attribute information and first host connection information, and a second mapping between the second tenant attribute information and second host connection information.

5. The DHCP server system of claim 4, wherein the determining, by the DHCP relay agent, first tenant attribute information of the first host comprises:
determining the first host connection information based on the first VLAN identifier; and
deriving the first VRF identifier based on the first host connection information and the switch configuration information; and the determining, by the DHCP relay agent, second tenant attribute information of the second host comprises:
determining the second host connection information based on the second VLAN identifier; and
deriving the second VRF identifier based on the second host connection information and the switch configuration information.

6. The DHCP server system of claim 4, wherein the DHCP relay agent is implemented on a switch, the first host connection information defines a first connection of the first host to a first port on the switch and the second host connection information defines a second connection of the second host to a second port on the switch.

7. The DHCP server system of claim 1, wherein the first DHCP message comprises a first DHCP discover message; and assigning, by the DHCP server, a first IP address to the first host comprises:
transmitting, to the DHCP relay agent, a first DHCP offer message in unicast form that includes the assigned first IP address;
converting, by the DHCP relay agent, the first DHCP offer message into a broadcast first DHCP offer message; and
transmitting, to the first host, by the DHCP relay agent, the broadcast first DHCP offer message.

8. The DHCP server system of claim 7, wherein the assigning, by the DHCP server, a first IP address to the first host comprises:
obtaining, by the DHCP relay agent, a first broadcasted DHCP request message from the first host within the first VLAN in broadcast form;
determining, by the DHCP relay agent, the first tenant attribute information of the first host based on the switch configuration information;
augmenting, by the DHCP relay agent, the first broadcasted DHCP request message with the determined first tenant attribute information;
converting, by the DHCP relay agent, the first broadcasted DHCP request message to a unicast form; and
transmitting, by the DHCP relay agent, the unicast augmented first DHCP request message to the DHCP server.

9. The DHCP server system of claim 1, wherein the computer instructions when executed by the one or more hardware processors are further configured to perform:
detecting, by the DHCP server, a third DHCP message devoid of tenant attribute information;
flagging, by the DHCP server, the third DHCP message as nonconforming; and
dropping, by the DHCP server, the third DHCP message.

10. The DHCP server system of claim 1, wherein augmenting, by the DHCP relay agent, the first broadcasted DHCP message comprises adding the first tenant attribute information to a tenant attribute field within a header of the DHCP message.

11. A method implemented by a multi-tenant Dynamic Host Configuration Protocol (DHCP) server system comprising a DHCP relay agent and a DHCP server, the method comprising:
in a first process:
obtaining, by the DHCP relay agent, a first broadcasted DHCP message from a first host within a first Virtual Local Area Network (VLAN);
determining, by the DHCP relay agent, first tenant attribute information of the first host based on switch configuration information;
augmenting, by the DHCP relay agent, the first broadcasted DHCP message with the determined first tenant attribute information;
converting, by the DHCP relay agent, the first broadcasted DHCP message to a unicast form; and
transmitting, by the DHCP relay agent, the unicast augmented first DHCP message to the DHCP server;
in a second process:
obtaining, by the DHCP relay agent, a second broadcasted DHCP message from a second host within a second VLAN;
determining, by the DHCP relay agent, second tenant attribute information of the second host based on switch configuration information;
augmenting, by the DHCP relay agent, the second broadcasted DHCP message with the determined second tenant attribute information;
converting, by the DHCP relay agent, the second broadcasted DHCP message to a unicast form; and
transmitting, by the DHCP relay agent, the unicast augmented second DHCP message to the DHCP server; and
in a third process:
identifying, based on the unicast augmented first DHCP message, by the DHCP server, a first tenant associated with the first host;
identifying, based on the unicast augmented second DHCP message, by the DHCP server, a second tenant associated with the second host;
assigning, by the DHCP server, a first Internet Protocol (IP) address to the first host from a first allocated subspace of IP addresses for the first tenant and a second IP address to the second host from a second allocated subspace of IP addresses for the second tenant; and
provisioning first tenant configuration parameters for the first host and second tenant configuration parameters for the second host.

12. The method of claim 11, wherein the first allocated subspace and the second allocated subspace are at least partially overlapping.

13. The method of claim 11, wherein the first tenant attribute information comprises a first VLAN identifier and a first Virtual Routing and Forwarding (VRF) identifier which identifies a first routing instance for the first broadcasted DHCP message, and the second tenant attribute information comprises a second VLAN identifier and a second VRF identifier which identifies a second routing instance for the second broadcasted DHCP message.

14. The method of claim 13, wherein the switch configuration information comprises a first mapping between the first tenant attribute information and first host connection information, and a second mapping between the second tenant attribute information and second host connection information.

15. The method of claim 14, wherein the determining, by the DHCP relay agent, first tenant attribute information of the first host comprises:
determining the first host connection information based on the first VLAN identifier; and
deriving the first VRF identifier based on the first host connection information and the switch configuration information; and the determining, by the DHCP relay agent, second tenant attribute information of the second host comprises:
determining the second host connection information based on the second VLAN identifier; and
deriving the second VRF identifier based on the second host connection information and the switch configuration information.

16. The method of claim 14, wherein the DHCP relay agent is implemented on a switch, the first host connection information defines a first connection of the first host to a first port on the switch and the second host connection information defines a second connection of the second host to a second port on the switch.

17. The method of claim 11, wherein the first DHCP message comprises a first DHCP discover message; and assigning, by the DHCP server, a first IP address to the first host comprises:
transmitting, to the DHCP relay agent, a first DHCP offer message in unicast form that includes the assigned first IP address;
converting, by the DHCP relay agent, the first DHCP offer message into a broadcast first DHCP offer message; and
transmitting, to the first host, by the DHCP relay agent, the broadcast first DHCP offer message.

18. The method of claim 17, wherein the assigning, by the DHCP server, a first IP address to the first host comprises:
obtaining, by the DHCP relay agent, a first broadcasted DHCP request message from the first host within the first VLAN in broadcast form;
determining, by the DHCP relay agent, the first tenant attribute information of the first host based on the switch configuration information;
augmenting, by the DHCP relay agent, the first broadcasted DHCP request message with the determined first tenant attribute information;
converting, by the DHCP relay agent, the first broadcasted DHCP request message to a unicast form; and
transmitting, by the DHCP relay agent, the unicast augmented first DHCP request message to the DHCP server.

19. The method of claim 18, further comprising:
detecting, by the DHCP server, a third DHCP message devoid of tenant attribute information;
flagging, by the DHCP server, the third DHCP message as nonconforming; and
dropping, by the DHCP server, the third DHCP message.

20. The method of claim 11, wherein augmenting, by the DHCP relay agent, the first broadcasted DHCP message comprises adding the first tenant attribute information to a tenant attribute field within a header of the DHCP message.
